(19) United States
(12) Patent Application Publication
(10) Pub. No.: US 2018/0084736 A1
(43) Pub. Date: Mar. 29, 2018

(54) CULTIVATING TOOL

(71) Applicant: ZEED, LLC, Rancho Cucamonga, CA (US)

(72) Inventor: Adam Chin Shong Uy, Rancho Cucamonga, CA (US)

(73) Assignee: ZEED, LLC, Rancho Cucamonga, CA (US)

(21) Appl. No.: 15/814,740

(22) Filed: Nov. 16, 2017

Related U.S. Application Data
(63) Continuation-in-part of application No. 15/592,827, filed on May 11, 2017.
(60) Provisional application No. 62/444,159, filed on Jan. 9, 2017.
(60) Provisional application No. 62/379,699, filed on Aug. 25, 2016.

(51) Int. Cl. A01G 9/12; A01G 9/02; A01G 13/10

(52) U.S. Cl. CPC A01G 9/12; A01G 13/10; A01G 9/022

(57) ABSTRACT

The disclosure herein is directed to a plant cultivation assembly. The plant cultivation assembly provides support for the plants to allow for proper plant growth. Specifically, the plant cultivation assembly allows for vertical plant growth without the need to use stakes. In one embodiment, the plant cultivation assembly may be used for vertical farming.

### RELATED APPLICATIONS

The present application is a continuation in part of U.S. application Ser. No. 15/592,827, entitled, “Cultivating Tool,” and filed on May 11, 2017, which claims priority to US provisional application No. 62/444,159, entitled, “Cultivating Tool,” and filed on Jan. 9, 2017, and also claims priority to US provisional application No. 62/379,699, entitled, “Cultivating Tool,” and filed on Aug. 25, 2016. The disclosures of all related applications are incorporated herein by reference in their entirety.

### FIELD OF THE INVENTION

The disclosure herein is directed to a plant cultivation assembly. The plant cultivation assembly provides support for the plants to allow for proper plant growth. Specifically, the plant cultivation assembly allows for vertical plant growth without the need to use wooden stakes. In one embodiment, the plant cultivation assembly may be used for vertical farming.

### BACKGROUND

Plant cultivation is a delicate process. One must care for plants in a specific environment: using viable soil, hydrate at specific pH levels and ensure temperatures agree to the plants ecosystem. One common issue that growers face during the growth stages is the “vertical rise” in which the plant grows. In common practices a wooden stake is utilize, the stake is attached to the plant and dug securely into the soil base. The staking system works for cultivating plants however the cost and time associated to stake each plant individually, the high risk of puncturing the plants roots and the time consumption at harvest creates inefficiency in the process.

### SUMMARY

The following simplified summary provides a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented below.

In one embodiment is a plant cultivation assembly. The assembly includes a tray, net, stand, and pole. When assembled, the poles hold the net over the tray. The pole is kept upright using the stand. The stand sits inside the tray at the bottom. The pole attaches to the stand at one end. The other end of the pole attaches to the net.

In another embodiment is a plant cultivation assembly. The assembly includes a tray, net, stand, plate, and pole. When assembled, the poles hold the net over the tray. The pole is kept upright using the plate and stand. The plate attaches to the top edge of the tray and the stand sits inside the tray at the bottom. The pole attaches to both the plate and the stand at one end. In some embodiments, the plate has a hole through which the pole passes. The end of the pole attaches to the net.

The shape and size of the tray may vary. The shape and size of the net should be large enough to cover the tray. The number of poles may vary depending on the shape and size of the tray. For each pole there is one base and optionally one plate. For example, if the tray is generally square, a pole, base, and optionally plate may be used in each corner of the tray. For a large tray, a pole, base, and optionally plate may be used in the corners or along the edge and additional pole and base may be positioned away from the edge, e.g. the center.

In some embodiments, the height of the net is adjustable. In one embodiment, the height may be adjusted by changing the length of the poles. This can be accomplished by either adding/removing lengths of the pole or by using a telescopic pole. In another embodiment, the net is moved up or down the length of the pole.

In some embodiments, the plate may be attached to the tray using a variety of different fastening mechanism. Non-limiting examples include nuts and bolts, screws, clips, snap-like fasteners, adhesive, and the like. In some embodiments, the plate may be attached to the pole using a variety of different fastening mechanisms. Non-limiting examples include fittings (e.g. hole), couplings, cut-out, clips, string ties, hook and loop fastener, adhesive, and the like. In some embodiments, the pole may be attached to the base using a number of different fastening mechanisms. Non-limiting examples include nuts and bolts, screws, nails, fittings (e.g. hole or end cap), couplings, snap-like fitting, skewer/dowel, insert, adhesive, and the like. In some embodiments, the net may be attached to the pole using a variety of different fastening mechanisms. Non-limiting examples include protrusions, hooks, clips, flanges, burrs, partially inserted nails, screws, or bolts, and the like.

In some embodiments, the parts of the plant cultivation assembly may be made from a variety of different materials. Non-limiting examples include biodegradable materials, paper, fiber, peat, plant husks, manure, metal, non-corrosive metals, composite metals, plastic, twine, wire, fabric, nylon, acrylic, rubber, carbon fiber, fiberglass composites, and the like. In one embodiment the parts are made using different materials. In other embodiments, two or more parts are made using the same material. For example, the pole, stand, and if using plate may be made from the same material.

In some embodiments, the plant cultivation assembly may be used indoor or outdoor. In one embodiment, the plant cultivation assembly may be used for vertical farming.

When all parts are utilized as the invention has been designed and intended, the consumer will benefit from saving time, ensure that the roots of their plants have not been punctured, and have reached maximum potential growth in height and width.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments of the disclosure. These drawings are provided to facilitate the reader's understanding of the disclosure and shall not be considered limiting of the breadth, scope, or applicability of the disclosure. It should be noted that for clarity and ease of illustration these drawings are not necessarily made to scale.

Some of the figures included herein illustrate various embodiments of the disclosure from different viewing angles. Although the accompanying descriptive text may refer to such views as “top,” “bottom,” or “side” views, such references are merely descriptive and do not imply or require that the invention be implemented or used in a particular spatial orientation unless explicitly stated otherwise.

FIG. 1 illustrates a non-limiting embodiment of a front view of a plate.

FIG. 2 illustrates a non-limiting embodiment of side view of a plate.

FIG. 3 illustrates a non-limiting embodiment of a perspective view of a plate.

FIG. 4 illustrates a non-limiting embodiment of a bottom view of a plate.

FIG. 5 illustrates a non-limiting embodiment of a perspective view of a plate.

FIG. 6 illustrates a non-limiting embodiment of a perspective view of a plate.

FIG. 7 illustrates a non-limiting embodiment of a perspective view of a plate.

FIG. 8 illustrates a non-limiting embodiment of a front view of a stand.

FIG. 9 illustrates a non-limiting embodiment of a top view of a stand.

FIG. 10 illustrates a non-limiting embodiment of a side view of a stand.

FIG. 11 illustrates a non-limiting embodiment of a perspective view of the stand.

FIG. 12 illustrates a non-limiting embodiment of a perspective view of the stand.

FIG. 13 illustrates a non-limiting embodiment of a perspective view of the stand.

FIG. 14 illustrates a non-limiting embodiment of a perspective view of the stand.

FIG. 15 illustrates a non-limiting embodiment of a perspective view of a pole.

FIG. 16 illustrates a non-limiting embodiment of a partially assembled view of the pole, plate, and stand.

FIG. 17 illustrates a non-limiting embodiment of a front assembled view of the pole, plate, and stand.

FIG. 18 illustrates a non-limiting embodiment of a side assembled view of the pole, plate, and stand.

FIG. 19 illustrates a non-limiting embodiment of a perspective assembled view of the pole, plate, and stand.

FIG. 20 illustrates a non-limiting embodiment of an exploded view of the pole, plate, and stand.

FIG. 21 illustrates a non-limiting embodiment of a front assembled view of the pole, plate, and stand.

FIG. 22 illustrates a non-limiting embodiment of a side assembled view of the pole, plate, and stand.

FIG. 23 illustrates a non-limiting embodiment of a perspective assembled view of the pole, plate, and stand.

FIG. 24 illustrates a non-limiting embodiment of a side view of a tray.

FIG. 25 illustrates a non-limiting embodiment of a top view of a tray.

FIG. 26 illustrates a non-limiting embodiment of a perspective view of a tray.

FIG. 27 illustrates a non-limiting embodiment of a side view of a net.

FIG. 28 illustrates a non-limiting embodiment of a top view of a net.

FIG. 29 illustrates a non-limiting embodiment of a perspective view of a net.

FIG. 30 illustrates a non-limiting embodiment of a partially exploded perspective view of the pole, plate, stand, tray and net.

FIG. 31 illustrates a non-limiting embodiment of a partially exploded perspective view of the pole, plate, stand, tray and net.

FIG. 32 illustrates a non-limiting embodiment of a side assembled view of the pole, plate, stand, tray and net.

FIG. 33 illustrates a non-limiting embodiment of a top assembled view of the pole, plate, stand, tray and net.

FIG. 34 illustrates a non-limiting embodiment of a perspective assembled view of the pole, plate, stand, tray and net.

FIG. 35 illustrates a non-limiting embodiment of a top assembled view of the pole, plate, stand, tray and net.

FIG. 36 illustrates a non-limiting embodiment of a perspective assembled view of the pole, plate, stand, tray and net.

FIG. 37 illustrates a non-limiting embodiment of a side view of a tray.

FIG. 38 illustrates a non-limiting embodiment of a top view of a tray,

FIG. 39 illustrates a non-limiting embodiment of a perspective view of a tray.

FIG. 40 illustrates a non-limiting embodiment of a top view of a tray.

FIG. 41 illustrates a non-limiting embodiment of a cross-section view of a tray.

FIG. 42 illustrates a non-limiting embodiment of a cross-section view of a tray with tray, pole, and plate.

FIG. 43 illustrates a non-limiting embodiment of a top view of a tray and plate.

FIG. 44 illustrates a non-limiting embodiment of an exploded view of a tray, plate, and pole.

FIG. 45 illustrates a non-limiting embodiment of a top view of a tray, pole, plate, and net.

FIG. 46 illustrates a non-limiting embodiment of a perspective view of a pole, plate, and net.

### DETAILED DESCRIPTION

The present disclosure is directed to a plant cultivation assembly. The device is adjustable to accommodate the vertical and horizontal growth of the plants.

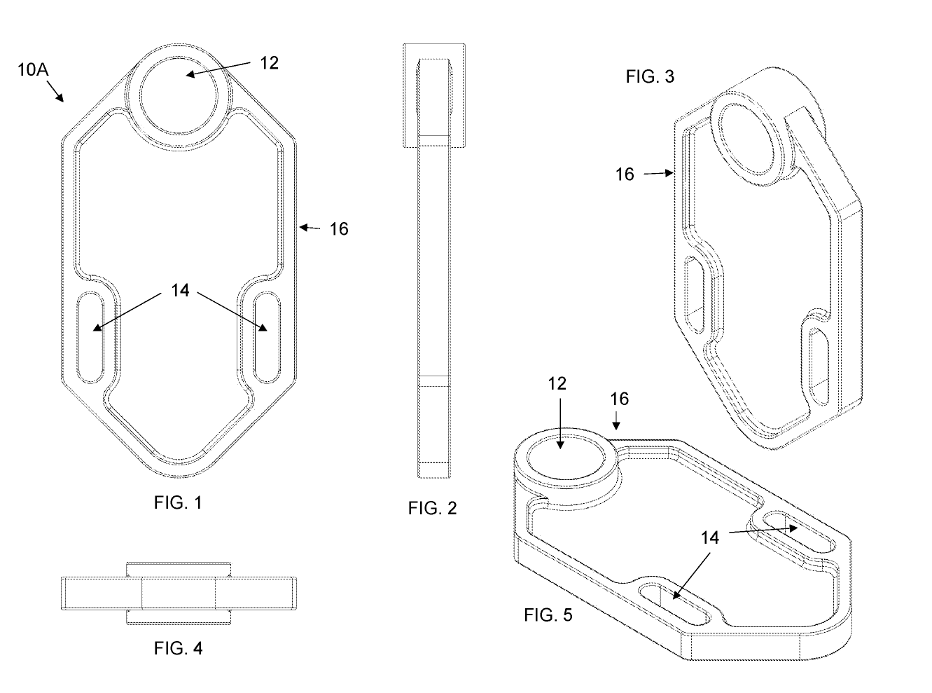

Turning to the figures, FIGS. 1 through 5 illustrate embodiment A of a plate 10. In this embodiment, plate 10 is an elongated hexagon forming a diamond-like shape. Plate 10 has holes 12 and 14. Holes 12 and 14 may be any shape, including but not limited to circular, oval, triangular, square, rectangular, and polygonal. In one embodiment, hole 10 is used to support a pole or post and holes 14 are used attach plate 10 to another surface. As illustrated in FIGS. 3 and 4, the outer edge 16 of plate 10 is flanged, the flange also surrounds holes 12 and 14. As illustrated in FIGS. 2 though 5, the flange surrounding hole 12 is thicker than the rest of the of the plate edge.

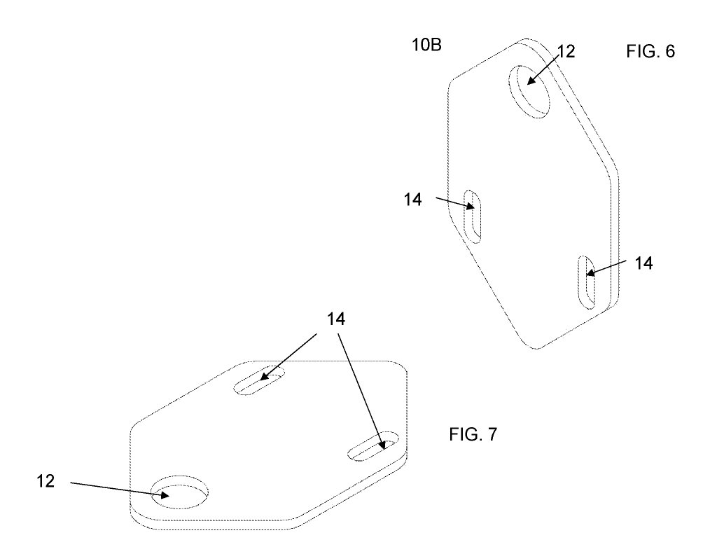

FIGS. 6 and 7 illustrate embodiment B of plate 10. In this embodiment, plate 10 has a fairly uniform thickness.

In other embodiments, plate 10 may have no holes. In this embodiment, plate 10 uses alternate means to support a pole or post. Non-limiting examples include a cut out that partially surrounds the pole or post, a strap to wrap around the pole or post, a clip that attaches to the pole or post, hook and loop fastener, adhesive, and the like. In this embodiment, plate 10 may be attached to another surface using alternate means. Non-limiting examples include fittings, couplings, clips, protrusions, snap-like system, adhesives, and the like. In yet other embodiments, plate 10 may have only one hole. Such hole may be used to either support a pole or post or to attach plate 10 to another surface.

Plate 10 may be made from a number of different materials, including but not limited to metal, non-corrosive metals, composite metals, plastic, nylon, acrylic, rubber, carbon fiber, fiberglass, composites, and the like.

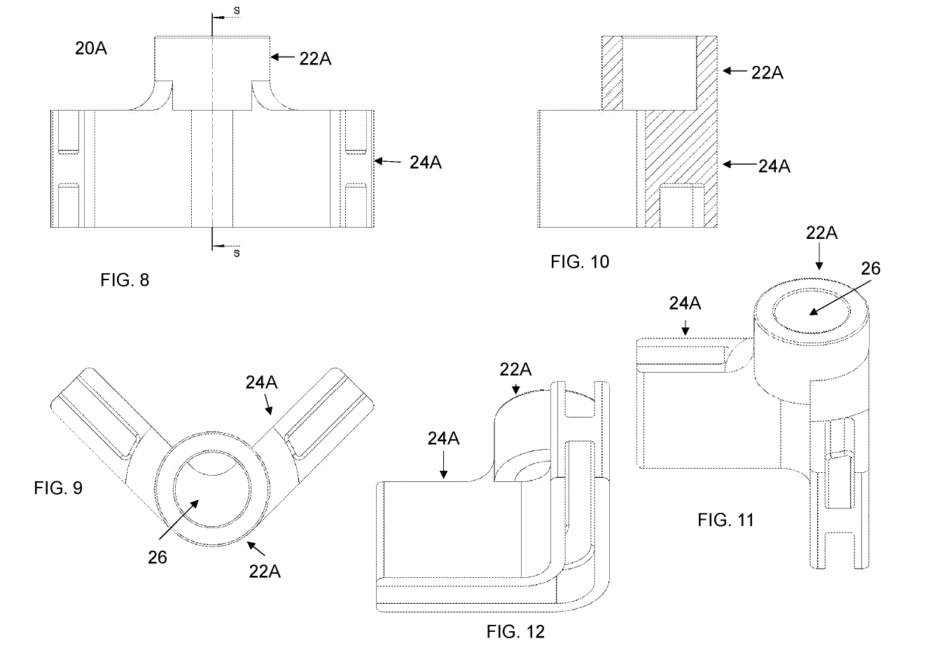

FIGS. 8 through 12 illustrate embodiment A of stand 20. Stand 20 has a holder 22 and a base 24. Base 24, as shown in FIGS. 9, 11, and 12, is roughly “V” shaped. Holder 22 is located at the junction of the “V” of base 24. Holder 22A has an opening 26 that can accommodate a pole or post. Holder 22A and opening 26 may be any shape, including but not limited to circular, oval, triangular, square, rectangular, and polygonal. In some embodiments, the exterior shape of holder 22A is different from the opening 26 shape. For example, the exterior may be circular whereas the opening is polygonal or the exterior may be triangular whereas then opening is circular. Base 24 provides stability for stand 20. In the embodiment illustrated in FIGS. 8, 11, and 12, base 24 has an “H” shaped cross section. The “H” shaped cross section provides rigidity while reducing the weight of the stand 20.

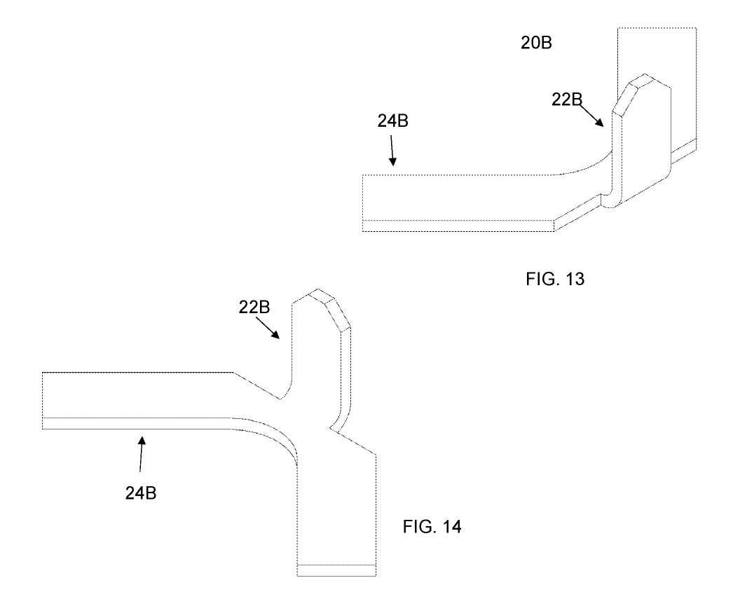

FIGS. 13 and 14 illustrate embodiment B of stand 20. In this embodiment, holder 22B accommodates a pole or post by being inserted into the pole or post. The shape of 22B may be any shape that can be inserted into the pole or post. In some embodiments, the shape may be pointed in order to pierce into the pole or post.

Stand 20 may be made from a number of different materials, including but not limited to metal, non-corrosive metals, composite metals, plastic, nylon, acrylic, rubber, carbon fiber, fiberglass, composites, and the like.

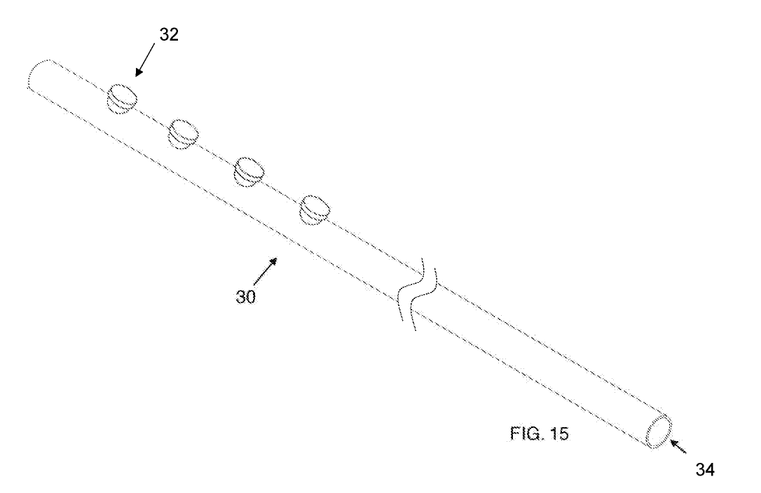

FIG. 15 illustrate pole 30. Pole 30 has at least one protrusion 32. Often pole 30 has at least 2 or at least 3 or at least 4 or at least 5 protrusions. In one embodiment, the protrusions form a line along the vertical length of the pole. In other embodiments the protrusions are randomly placed on the pole. Protrusion 32 is used to attach items to pole 30. In the embodiment illustrated, pole 32 has a hollow section 34 at one end. Protrusion 32 may be any shape that facilitates attachment. Non-limiting examples include hooks, clips, and the like. The hollow section 34 allows pole 32 to be attached to stand 20B (FIGS. 13 and 14). In another embodiment, pole 30 is hollow. In yet another embodiment, the length of pole 30 is adjustable. For example, additional pieces may be joined to pole 30 or pole 30 may be telescopic or have pieces that nest together to allow for different heights.

Pole 30 may be made from a number of different materials, including but not limited to metal, non-corrosive metals, composite metals, plastic, nylon, acrylic, rubber, carbon fiber, fiberglass, composites, and the like.

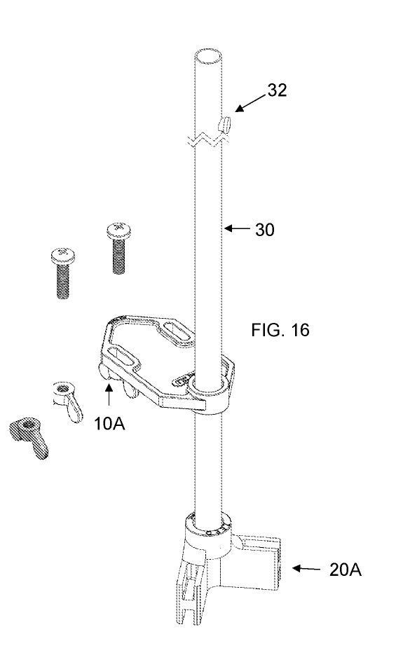

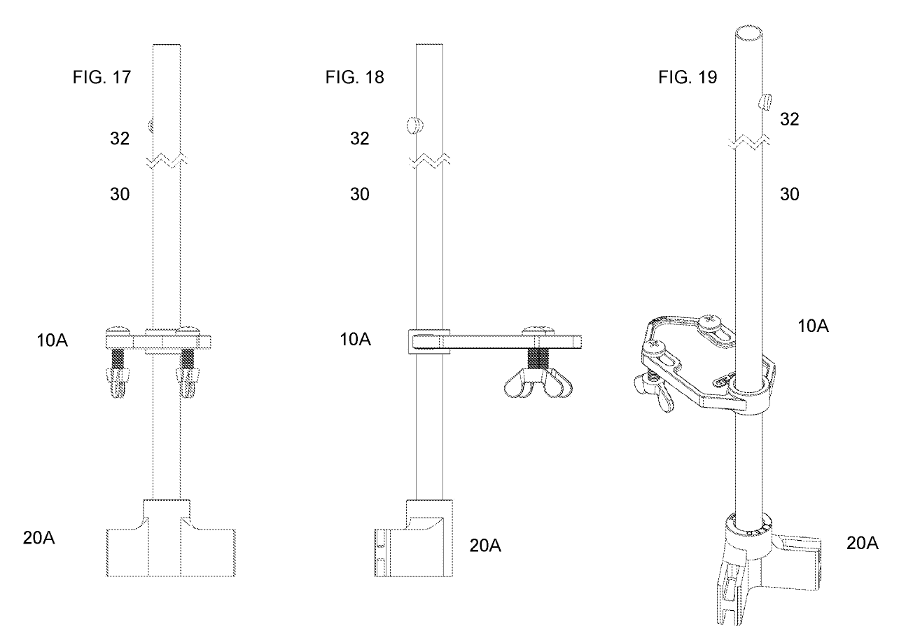

FIGS. 16 though 20 illustrates embodiment A of how plate 10A, stand 20A, and pole 30 are assembled. Pole 30 extends through hole 12 in plate 10A. One end of Pole 30 is inserted into opening 26 of holder 22A of stand 20A.

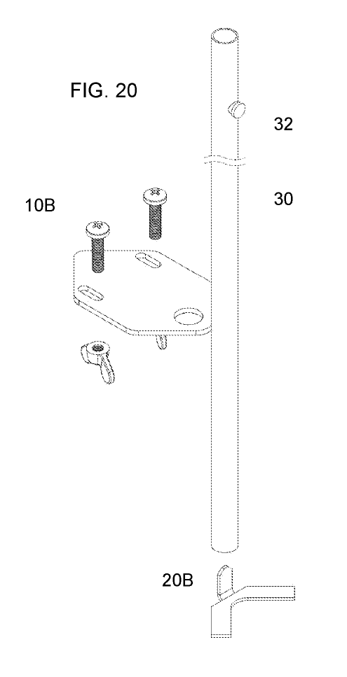

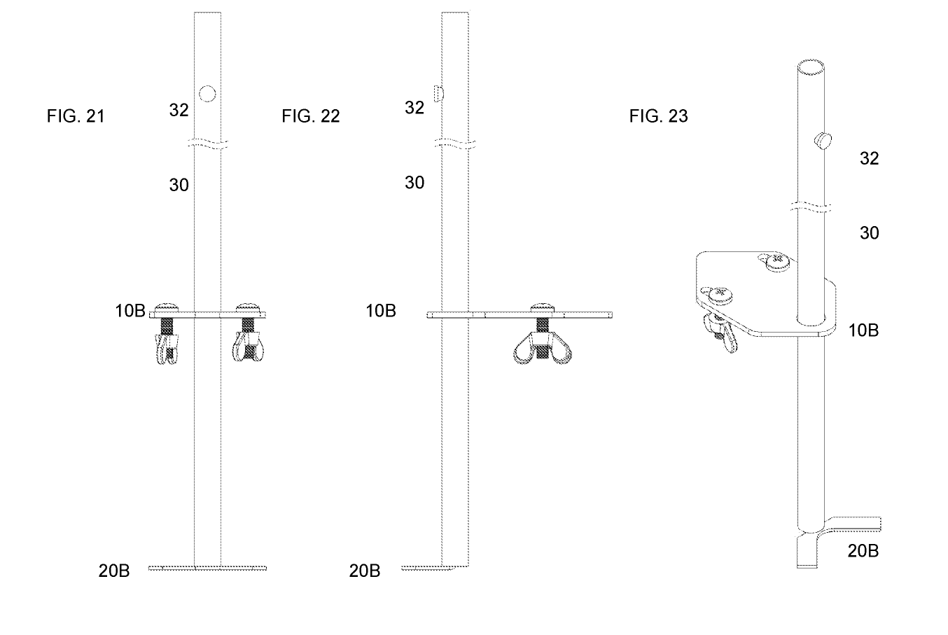

FIGS. 20 through 23 illustrate embodiment B of how plate 10B, stand 20B, and pole 30 are assembled. Pole 30 extends through hole 12 in plate 10B. Holder 22B of plate 20B is inserted into hollow section 34 of pole 30.

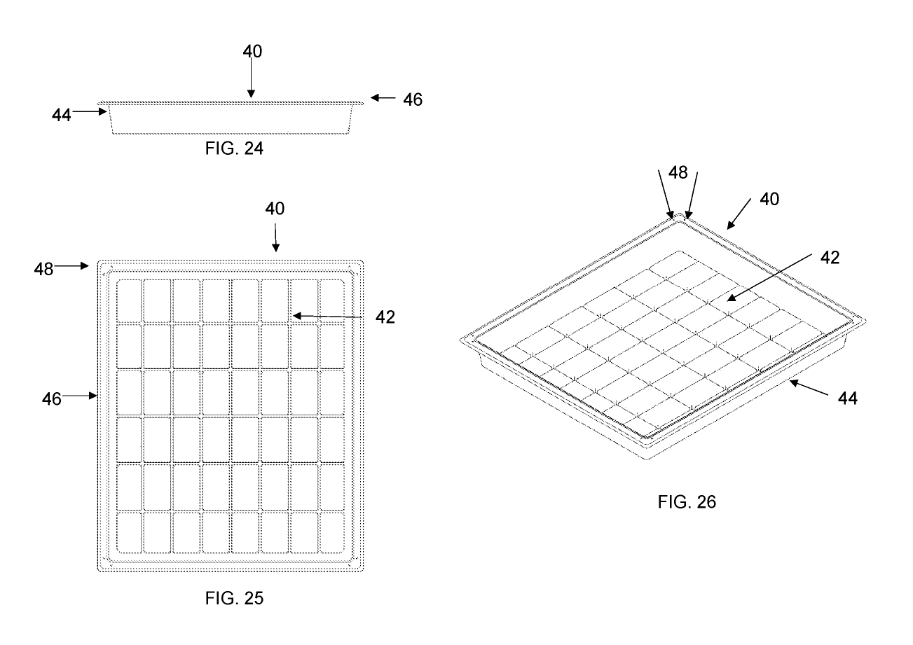

FIGS. 24 through 26 illustrate tray 40. In the embodiment illustrated, tray 40 has a roughly rectangular shape and has a bottom 42 and side 44 that extend upward from the bottom to form an open container. Side 44 has a top edge 46 that is flat. Top edge 46 is at least one hole 48. Often top edge 46 has a plurality of holes 48. Holes 48 are strategically place along top edge 46. Holes 48 are used to attach an item to tray 40. In the embodiment illustrated, top edge 46 has at least two holes 48 in each corner. In this embodiment, holes 48 are used to attach plate 10A to tray 40. In this embodiment, holes 14 in plate 10A align with holes 48 in tray 40. Any attachment mechanism may be used to attach plate 10A to tray 40. Non-limiting examples, include nuts and bolts, screws, clips, hooks, and the like. The bottom of tray 40 may be smooth, textured, sectioned, perforated, or the like. Sectioning and/or perforating the bottom may improve drainage. In one embodiment, the bottom of tray 40 may have a plurality of raised sections with a plurality of channels or valleys between each raised section.

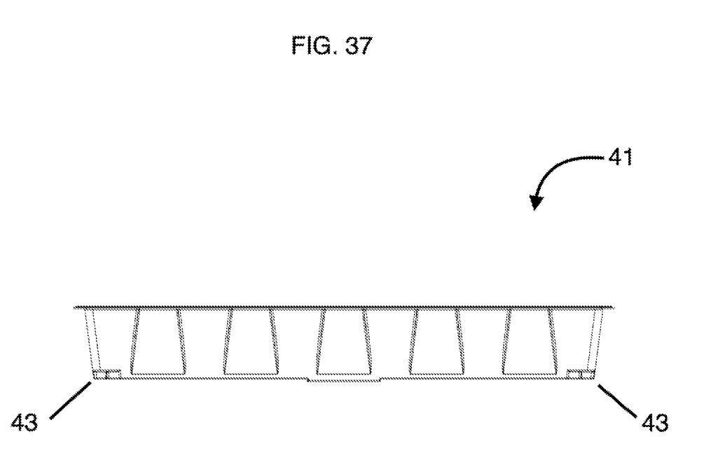

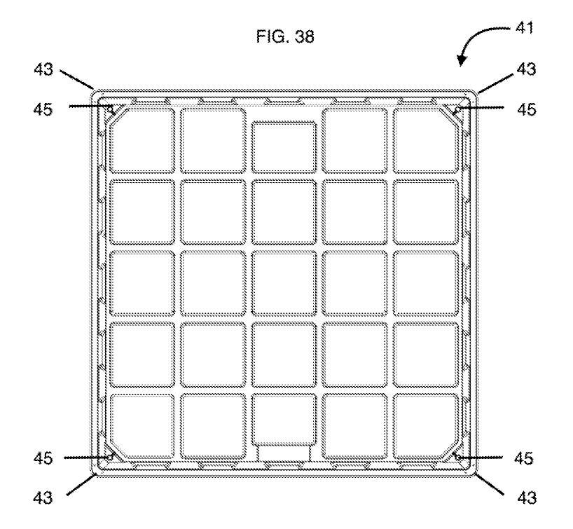

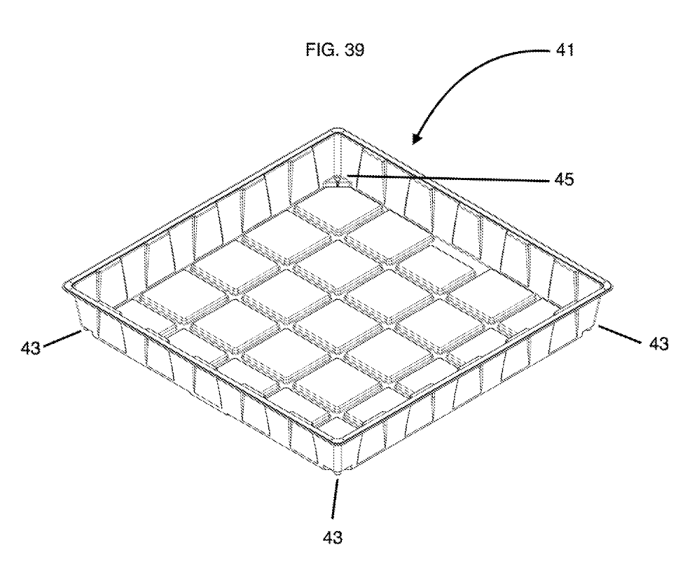

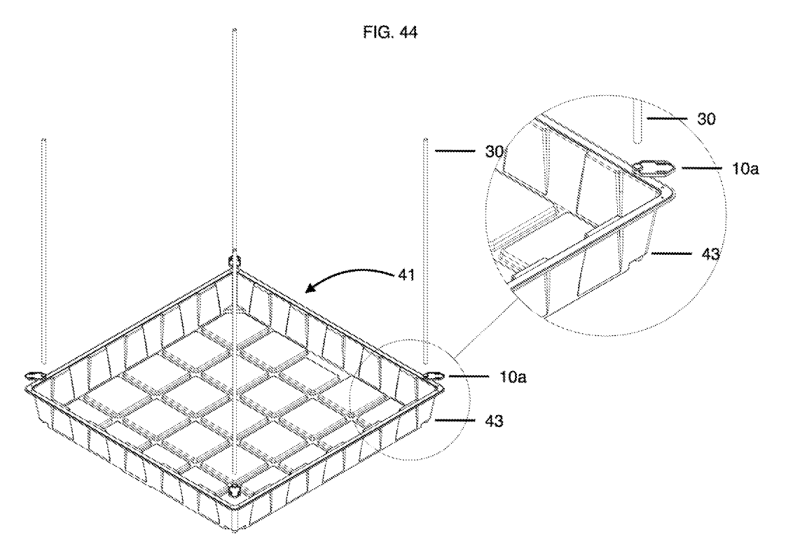

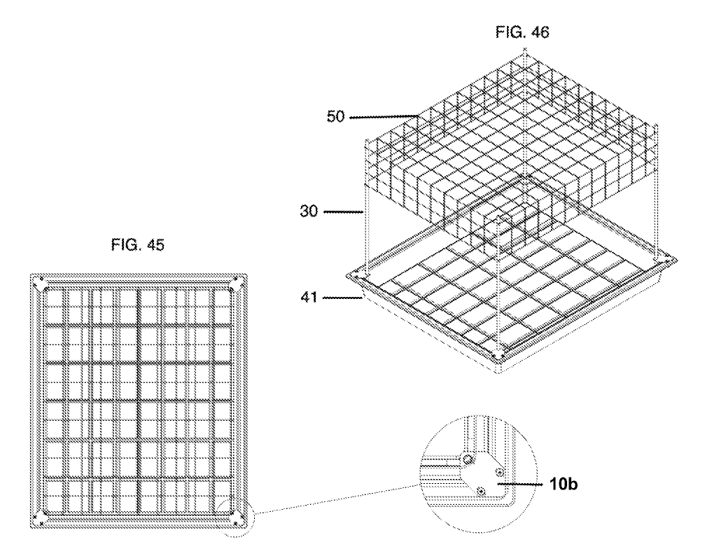

FIGS. 37 through 46 illustrate another embodiment of the tray 41. In the embodiment illustrated, tray 41 has corners that are designed to support one end of pole 30. In this embodiment, the bottom corners 43 of tray 41 have been shaped to create an indentation 45 in which one end of pole 30 sits. In other embodiments, indentation 45 can be placed anywhere on the bottom of tray 41.

In one embodiment, indentation 45 is generally the same shape as pole 30. For example, if the pole is cylindrical in shape, then indentation 45 is cylindrical in shape as well. In another embodiment, indentation 45 may be a different shape than pole 30, e.g. cuboid and cylindrical.

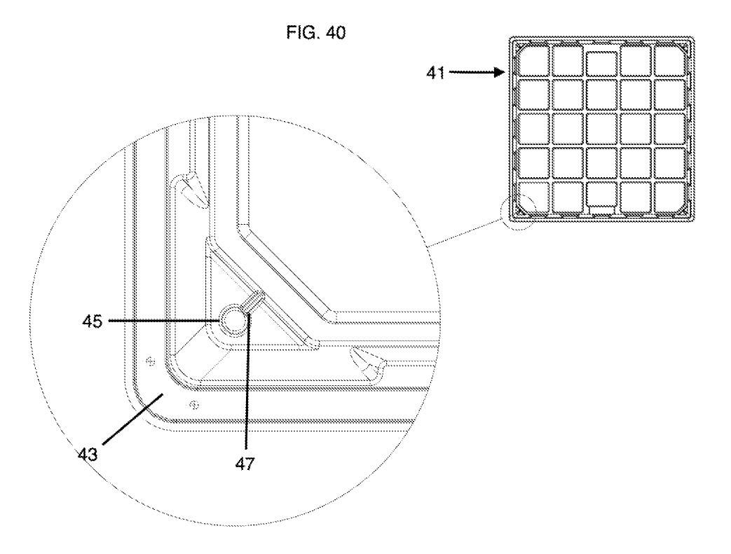

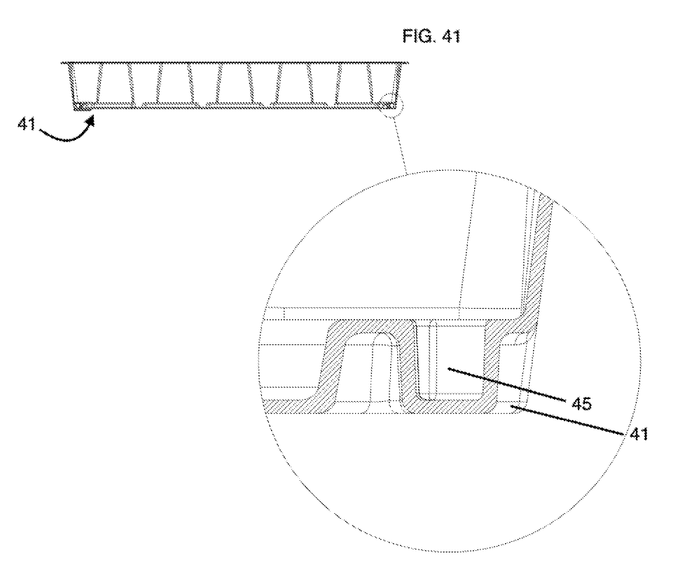

In one embodiment, indentation 45 surrounds a perimeter of pole 30. In another embodiment, indentation 45 does not surround a perimeter pole 30, as illustrated in FIG. 40. In this embodiment, indentation 45 has a gap 47. Gap 47 may allow for movement of pole 30, for example, allowing pole 30 to move with the wind. Gap 47 may also be use for drainage purposes. Gap 47 may also allow tray 41 to accommodate different sizes of pole 30. In one embodiment, indentation 45 has a beveled edge. The beveled edge may help with inserting pole 30.

In one embodiment, indentation 45 may have different depths. In one embodiment, indentation 45 is the same height as side 44 of tray 41. In another embodiment, indentation 45 is shorter than the height of side 44 of tray 41. In another embodiment, indentation 45 is less than half of the height of side 44 of tray 41. In another embodiment, indentation 45 is less than a quarter of the height of side 44 of tray 41. In another embodiment, indentation 45 is less than an eighth of the height of side 44 of tray 41. In another embodiment, indentation 45 is less than a sixteenth of the height of side 44 of tray 41.

In one embodiment, indentation 45 is continuous with tray 41. For example, indentation 45 can be molded into corners 43 of tray 41. Molding indentation 45 into corners 43 may be used when tray 41 is made from a deformable material, such as plastic, metal, polymers, composites, or glass.

In another embodiment, indentation 45 is made up of at least two different pieces. The first piece is continuous with the tray and the additional piece(s) fit into the corner 43 of tray 41. The additional piece(s) can be used to (1) provide additional support of pole 30; (2) adjust the depth of indentation 45; or (3) modify the shape of indention 45. In some embodiments, the additional pieces have a hole that aligns with indentation 45. In other embodiments the additional pieces have a second indentation that aligns with indentation 45. The height can be adjusted by stacking one or more of the additional pieces into the corner 43 of tray 41. In this embodiment, using additional pieces that have a hole that aligns with indentation 45 provides more support for pole 30. In this embodiment, using additional pieces that have a second indentation that aligns with indentation 45 raises pole 30. The shape of indentation 45 can be adjusted through use of an additional piece. In this embodiment, the additional piece has a second indentation that has differing top and bottom parts. The bottom part of the second indentation is similar in shape to indentation 45, whereas the top part of the second indentation is a different shape. For example, if indentation 45 is cylindrical, the bottom of the second indentation of the additional piece is also cylindrical whereas the top part of the second indentation can be cuboidal, triangular prism, polygonal prism, etc.

Tray 40 may be any shape, including but not limited to square, circular, oval, triangular, and polygonal. In one embodiment, tray 40 may be two trays, an inner tray and an outer tray. In this embodiment, the inner tray may be any number of seedling or growing pots that sit inside the outer tray and the outer tray is used to attach the plate/pole/stand assembly. Tray 40 may be made from a number of different materials, including but not limited to biodegradable materials, paper, fiber, peat, plant husks, manure, metal, non-corrosive metals, composite metals, plastic, nylon, acrylic, rubber, carbon fiber, fiberglass, composites, and the like.

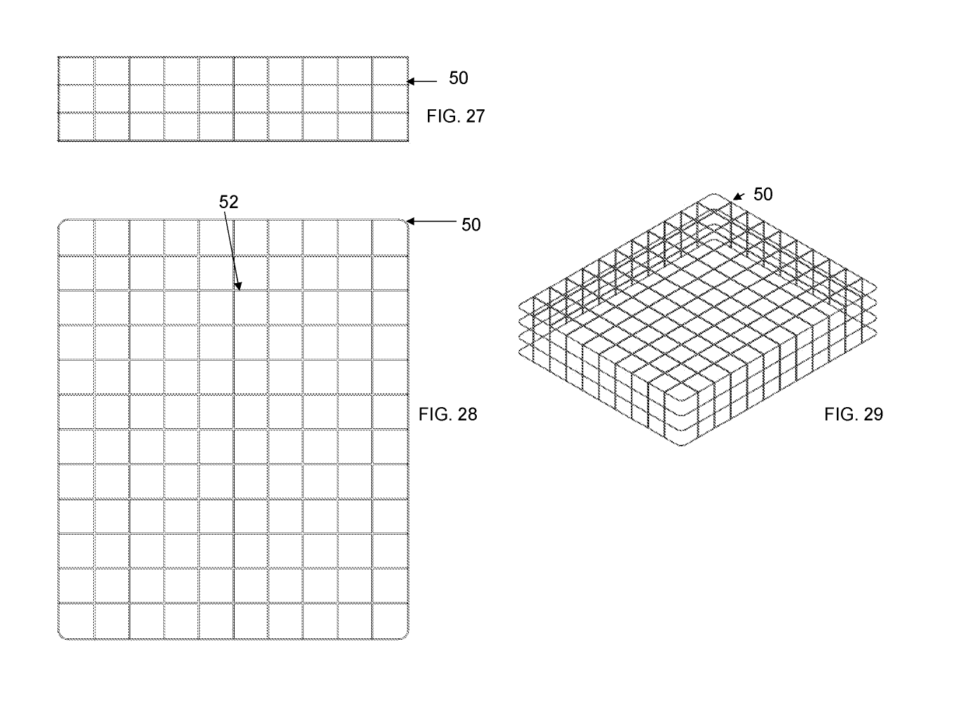

FIGS. 27 through 29 illustrate net 50. In most embodiments, net 50 is generally similar in shape to tray 40. Net 50 is made up of multiple strands 52. In one embodiment, strands 52 are spaced far enough apart to allow plants to grow through the net. In this embodiment, strands 52 provide support for the plants. On other embodiments, strands 52 are spaced close together to protect plants from animals, for example to protect fruit from birds.

Net 50 may be made from a number of different materials, including but not limited to metal, twine, plastic, and the like.

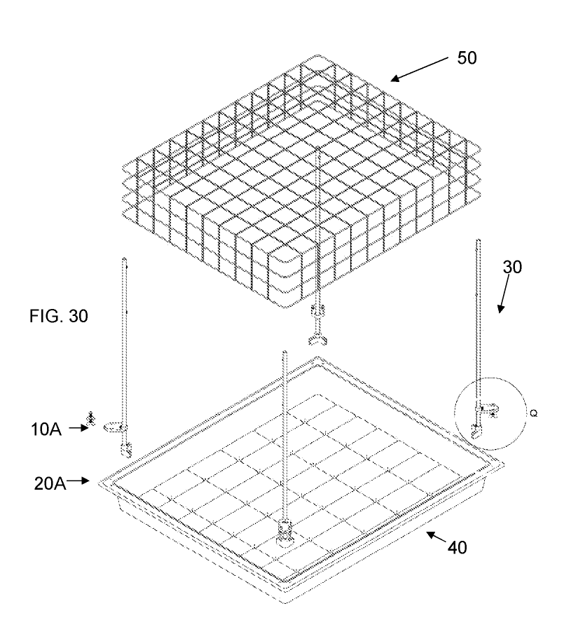

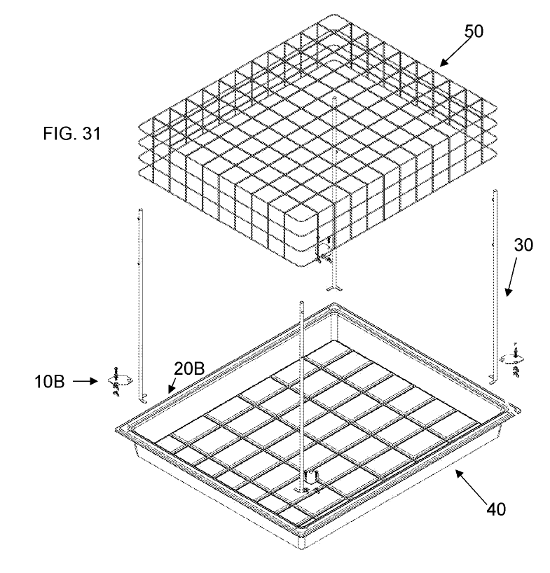

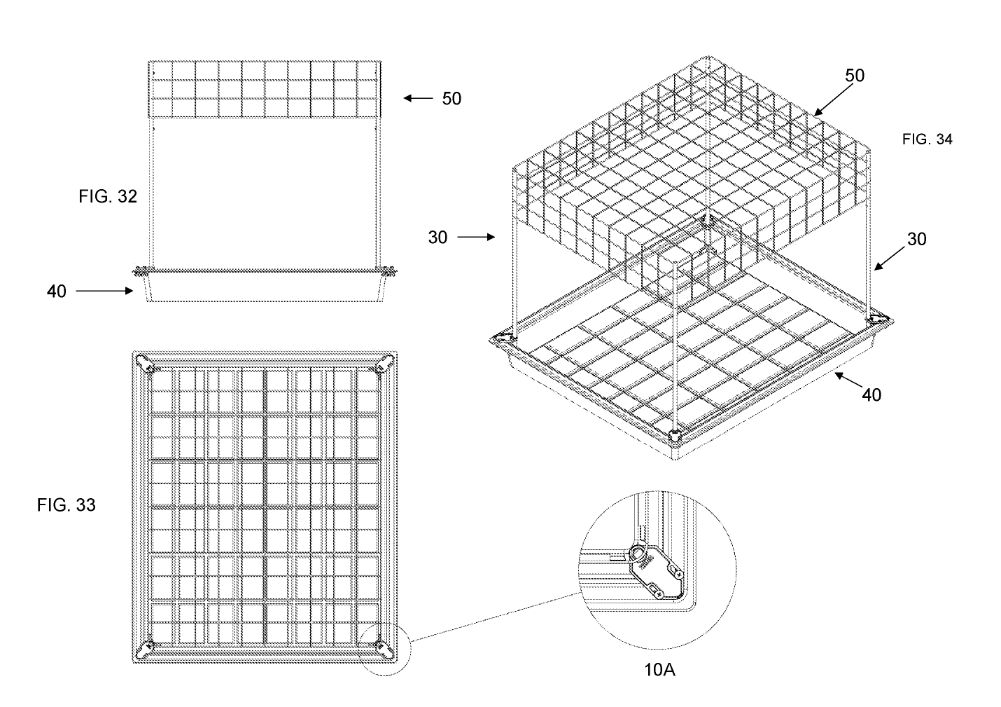

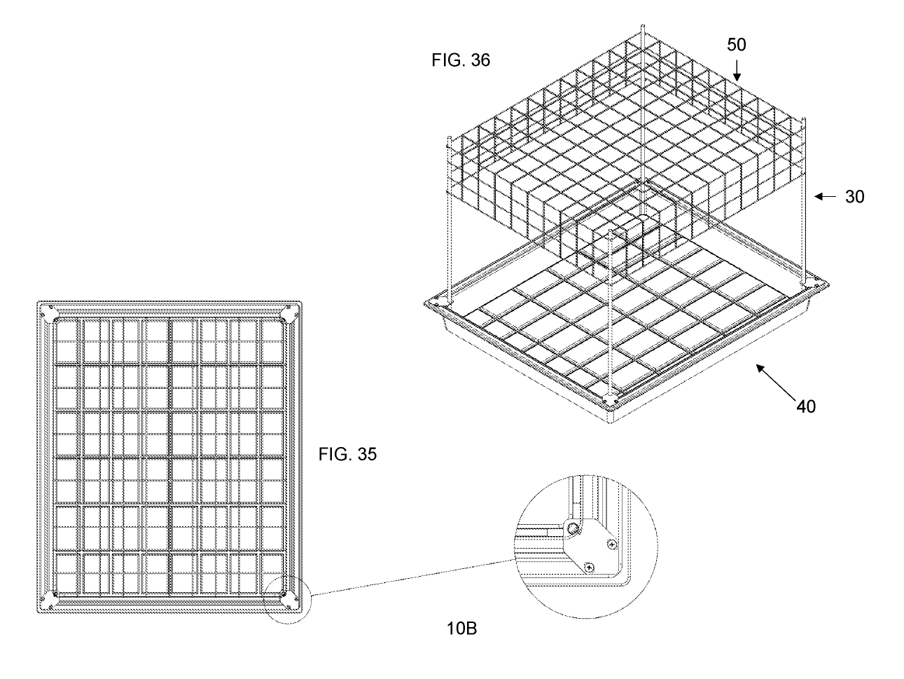

FIGS. 30 through 36 illustrate the plant cultivation assembly. Stand 20 is placed in the corner of tray 40, with the base 24 sitting on the bottom of the tray. Plate 10 is attached to the corner of tray 40 by placing a bolt through holes 14 and 48 and securing the bolt with a nut. Pole 30 passes though hole 12 in plate 10 and attaches to holder 22 of stand 20. Stand 20 and plate 10 keep pole 30 vertically/perpendicular from the bottom of the tray. Net 50 is attached to pole 30 using protrusion 32. In the embodiment illustrated, plate 10, stand 20, and pole 30 are place in each corner of tray 40. In other embodiments, plate 10, stand 20, and pole 30 may be placed anywhere along the edge of tray 40. In other embodiments, stand 20 and pole 30 may be placed away from the edge of tray 40. In this embodiment, the stand and pole are kept in place using planting soil, dirt, or seedling or growing pots. The overall number of plates 10, stands 20, and poles 30 used will depend on the shape and size of the tray and net.

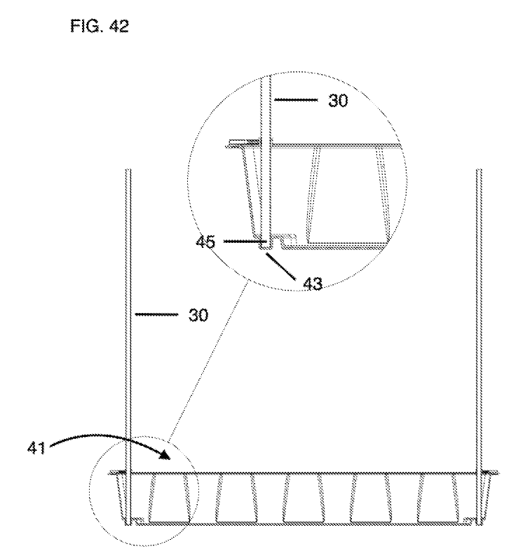

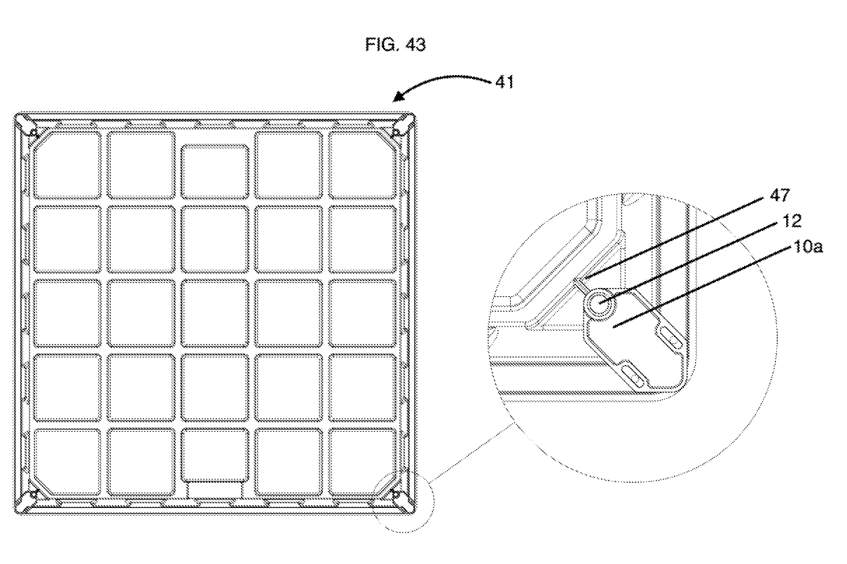

FIGS. 42 through 46 illustrate another embodiment of the plant cultivation assembly. In one embodiment, one end of pole 30 is placed in indentation 45 of tray 41. Plate 10 is attached to the corner of tray 41 by placing a bolt through holes 14 and 48 and securing the bolt with a nut. Pole 30 passes through hole 12 in plate 10. In the embodiment illustrated, plate 10 and pole 30 are placed in the corner of tray 41. In the embodiment illustrated, indentation 45 eliminates the need for stand 20.

In another embodiment, indentation 45 is the same height as side 44 of tray 41. In this embodiment, one end of pole 30 is placed in indentation 45 of tray 41. In this embodiment, indentation 45 eliminates the need for stand 20 and plate 10.

Unless defined otherwise, all technical and mechanical terms used herein have the same meaning as is commonly understood by one of ordinary skill in the art to which this disclosure belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed across multiple locations.

What is claimed is:

1. A plant cultivation assembly comprising:
a tray having a bottom, a side, a top edge, and an interior;
a net; and
at least one pole having a first end and a second end;
wherein the bottom of the tray has at least one indentation;
wherein the first end of the pole sits in the at least on indentation; and
wherein the net attaches to the pole at the second end.

2. The plant cultivation assembly of claim 1, further comprising a plate having at least one hole; wherein the plate attaches to the top edge of the tray; and wherein the pole passes though the at least one hole in the plate.

3. The plant cultivation assembly of claim 1, wherein second end of the pole further has at least one protrusion for attaching to the net.

4. The plant cultivation assembly of claim 3, wherein the protrusion is a hook or a clip.

5. The plant cultivation assembly of claim 1, wherein the pole further is a telescopic pole.

6. The plant cultivation assembly of claim 1, wherein the number of the pole and the at least one indentation is four.

7. The plant cultivation assembly of claim 2, wherein the plate is made from metal, non-corrosive metals, composite metals, plastic, nylon, acrylic, rubber, carbon fiber, fiberglass or composites.

8. The plant cultivation assembly of claim 1, wherein the pole is made from metal, non-corrosive metals, composite metals, plastic, nylon, acrylic, rubber, carbon fiber, fiberglass or composites.

9. The plant cultivation assembly of claim 1, wherein the tray is made from biodegradable materials, paper, fiber, peat, plant husks, manure, metal, non-corrosive metals, composite metals, plastic, nylon, acrylic, rubber, carbon fiber, fiberglass or composites.

10. A method for growing plants comprising the steps of:
assembling the plant cultivation assembly of claim 1 with the exception of attaching the net;
adding soil to the interior of the tray;
placing plants or seeds in the soil; and
attaching the net.

11. The method of claim 10, wherein the plants are grown in indoors.

12. The method of claim 10, wherein the plants are grown using vertical farming.

13. A method for growing plants comprising the steps of:
assembling the plant cultivation assembly of claim 1 with the exception of attaching the net;
planting a plant or a seed into a biodegradable pot;
placing the biodegradable pot in the tray of the plant cultivation assembly; and attaching the net.

14. The method of claim 13, wherein the plants are grown in indoors.

15. The method of claim 13, wherein the plants are grown using vertical farming.
